(19) United States
(12) Patent Application Publication
(10) Pub. No.: US 2023/0322311 A1
(43) Pub. Date: Oct. 12, 2023

(54) CONTAINER CHASSIS WITH DETACHABLE BOLSTER ENDS

(71) Applicants: PANUS USA LLC, Kearny, NJ (US); PANUS ASSEMBLY CO., LTD, Panusnikhom (TH)

(72) Inventors: Ayman AWAD, Staten Island, NY (US); Gautam RAMAMURTHY, Phanat Nikhom (TH)

(73) Assignees: PANUS USA LLC, Kearny, NJ (US); PANUS ASSEMBLY CO., LTD, Panusnikhom (TH)

(21) Appl. No.: 18/133,352

(22) Filed: Apr. 11, 2023

Related U.S. Application Data
(60) Provisional application No. 63/330,228, filed on Apr. 12, 2022.

(51) Int. Cl. B62D 53/06; B62D 63/08; B60P 1/64

(52) U.S. Cl. CPC B62D 53/067; B62D 63/08; B60P 1/6418; B62D 53/061

(57) ABSTRACT

A container chassis with detachable bolster ends comprising a plurality of bolsters, each bolster with detachable bolster ends and a first configuration with detached bolster ends wherein the container chassis is less than eight feet in width for horizontal fitment into an ISO shipping container. The container chassis with detachable bolster ends may also be configured to stack vertically within a plurality of container chassis and wheeled into the ISO shipping container.

### RELATED APPLICATIONS

This application is the non-provisional of U.S. provisional patent application No. 63/330,228 filed on Apr. 12, 2022, to which priority is claimed, and which is incorporated herein by reference.

### BACKGROUND OF THE INVENTION

Nearly all ocean cargo, and therefore, a large percentage of international trade, moves in intermodal containers. A container chassis, also called an intermodal chassis or skeletal trailer, is a type of semi-trailer designed to securely carry an intermodal container. These chassis are used by truckers to deliver containers between ports, railyards, container depots, and shipper facilities. Container chassis themselves may be shipped in intermodal containers.

Transport logistics generally, and meeting the demand for container chassis in any particular area of the world specifically, is a significant problem. Container chassis are relatively large and have unwieldy configurations in view of standardized intermodal containers (e.g. ISO shipping containers). Such standardized containers may be 20, 40, or 45 feet long. 8 ft wide, and between 8.5 and 9.5 ft high. In order to ship container chassis via ISO shipping container, contemporary chassis configurations, dimensions, and/or loading methods require that two chassis be tipped sideways then placed into a container. Consequently, per-chassis shipping costs are often relatively high—at the time of this application, between $4,000 and $5,000. Little innovation has taken place to change chassis configurations, dimensions, and/or loading methods to optimize the number of chassis that may be placed within standardized containers, to make loading methods more efficient, or to reduce per-chassis shipping costs.

Given the problems of meeting container chassis demand, unwieldy configurations, and resulting shipping limitations and costs, new container chassis configurations and loading methods are needed.

### SUMMARY OF THE INVENTION

In accordance with the above, a new and innovative container chassis with detachable bolster ends is provided. The problems of meeting container chassis demand, unwieldy configurations, and resulting shipping limitations and costs are solved. Embodiments of the present invention include a container chassis with detachable bolster ends comprising a plurality of bolsters, each bolster with detachable bolster ends and a first configuration with detached bolster ends wherein the container chassis is less than eight feet in width for horizontal fitment into an ISO shipping container. The container chassis with detachable bolster ends may also be configured to stack vertically within a plurality of container chassis and wheeled into the ISO shipping container.

These and other aspects of the present invention will become more fully apparent from the following description and appended claims, or may be learned by the practice of the invention as set forth hereinafter.

### BRIEF DESCRIPTION OF THE FIGURES

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings may not be drawn to scale. The invention will be described and explained with additional specificity and detail through the use of the accompanying drawings in which:

FIG. 1 is a perspective view of a typical prior art container chassis.

FIG. 2 is a perspective view of one embodiment of a container chassis with detachable bolster ends attached.

FIG. 3 is a perspective view of one embodiment of a container chassis with detachable bolster ends detached.

FIG. 4 is a perspective view of a front detachable bolster end in one embodiment of a container chassis with detachable bolster ends.

FIG. 5 is a perspective view of a middle detachable bolster end in one embodiment of a container chassis with detachable bolster ends.

FIG. 6 is a perspective view of a rear detachable bolster end in one embodiment of a container chassis with detachable bolster ends.

FIG. 7 is a top view of one embodiment of a container chassis with detachable bolster ends.

FIG. 8 is a side view of one embodiment of a container chassis with detachable bolster ends in an extended-chassis configuration.

FIG. 9 is a side view of one embodiment of a container chassis with detachable bolster ends in a contracted-chassis configuration.

FIG. 10 is a perspective view of a plurality of stacked container chassis with detachable bolster ends.

FIG. 11 is a perspective view of a plurality of stacked container chassis with detachable bolster ends in a shipping container environment.

### DETAILED DESCRIPTION OF THE ILLUSTRATED EMBODIMENT

The present invention in its various embodiments, some of which are depicted in the figures herein, is a container chassis with detachable bolster ends.

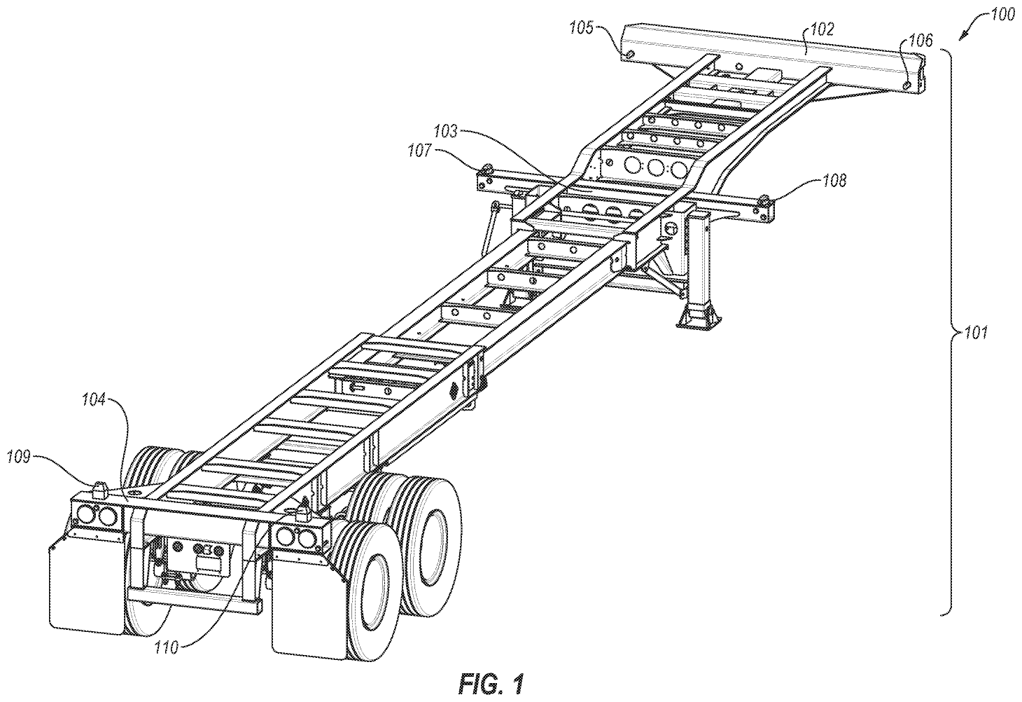

Referring now to FIG. 1, a typical (prior art) container chassis 100 is shown. The illustrated container chassis may be referred to as a 20-40 chassis, meaning that it may carry both 20 foot and 40 foot cargo containers. Chassis 100 is comprised of a main frame 101 with front-102, mid-103, and rear-104 bolsters. Front bolster 102 has two pin locks 105, 106 adjacent opposite ends of the bolster. Mid bolster 103 has a first set of twist locks 107, 108 adjacent opposite ends of the bolster. Rear bolster 104 has a second set of twist locks 109, 110 adjacent opposite ends of the bolster. Pin and twist locks are fully integrated with and/or or integrally formed into bolsters. Bolsters are not modular, nor are pin and/or twist locks or bolster components detachable.

Due to standardized shipping container dimensions (e.g., 8 feet wide) and configurations, containers require chassis lock locations and bolster widths that preclude typical container chassis (˜8 feet wide) from fitting horizontally inside of containers. Instead, two chassis (with widths that exceed the internal width of a container) are tipped sideways then placed into a container.

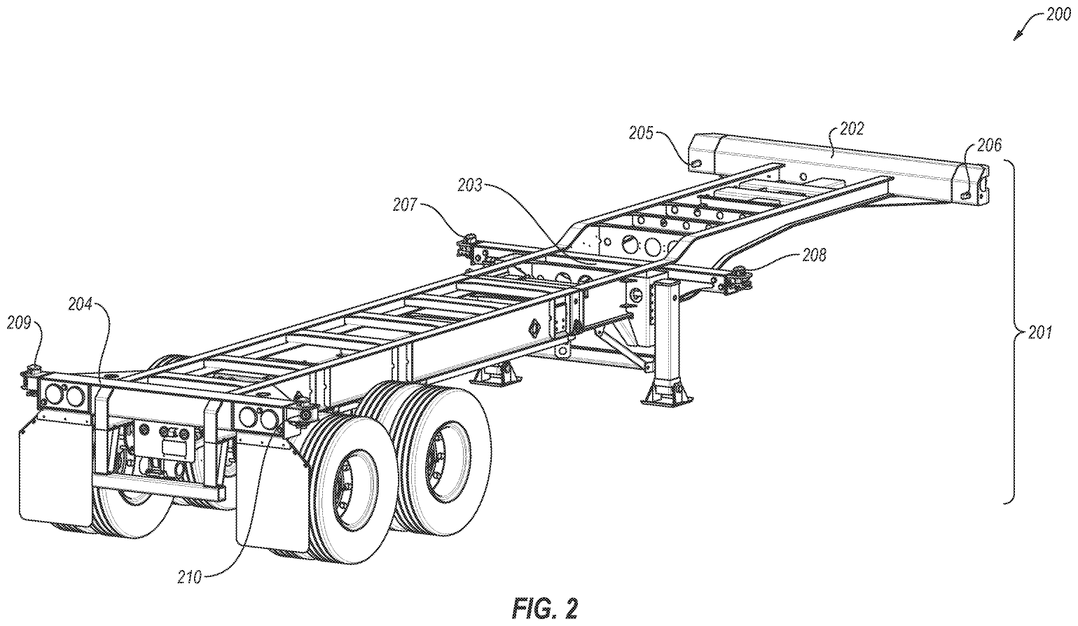

Referring now to FIG. 2, one embodiment of an improved container chassis with detachable bolster ends 200 is shown. As with typical container chassis 100, container chassis with detachable bolster ends 200 is also comprised of a main frame 201 with front-202, mid-203, and rear-204 bolsters. Front bolster 202 has two pin locks 205, 206 adjacent opposite ends. Mid bolster 203 has a first set of twist locks 207, 208 adjacent opposite ends. Rear bolster 204 has a second set of twist locks 209, 210 adjacent opposite ends.

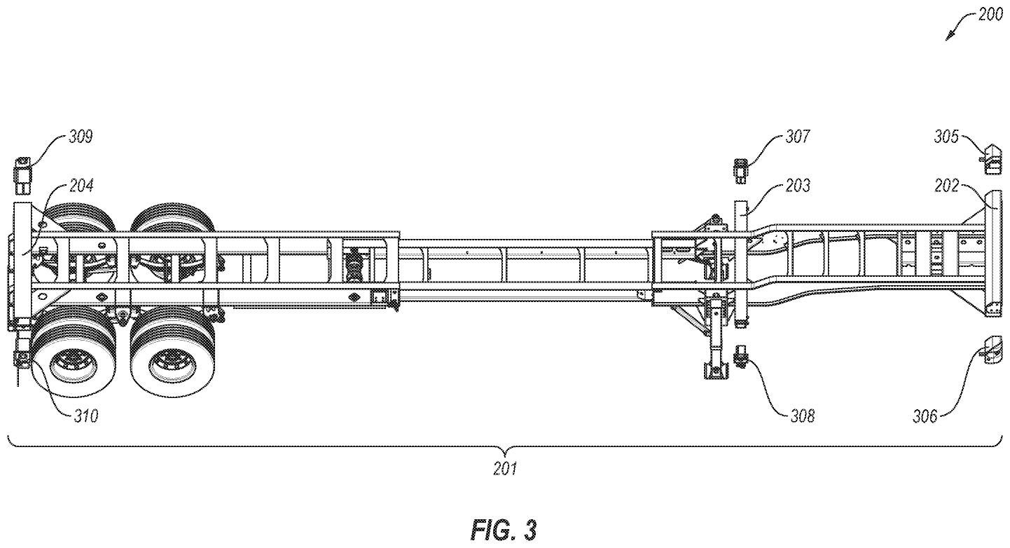

Significantly, the container chassis incorporates bolster ends and pin and/or twist locks that are modular and detachable and not fully integrated with and/or or integrally formed into bolsters. Referring now to FIG. 3, pin and/or twist locks are located on removably attachable bolster ends 305, 306, 307, 308, 309, 310 that, when removed, reduce the width of the container chassis main frame from 8 feet. Detachable bolster ends may be removably attached to bolsters by any number of means, including, but not limited to, nut and bolt or pin fasteners. Bolsters and/or bolster ends may be configured as male and/or female ends, respectively.

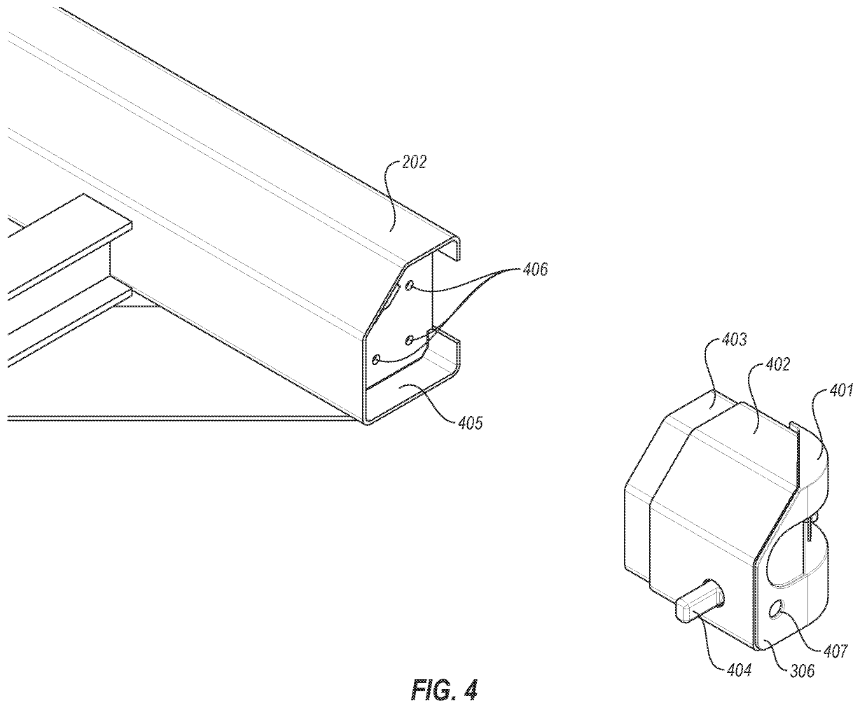

Referring now to FIG. 4, a front detachable bolster end 306 in one embodiment of a container chassis with detachable bolster ends is shown. Front detachable bolster end 306 has a rounded corner portion at one end 401 connected to a five-sided body portion 402 and a reduced diameter portion at a second end 403 that is configured to slide inside the front bolster 202. A twist lock 404 is located on the body portion 402, with a twist lock release-engagement mechanism adjacent the rounded corner portion 401. In operation, front detachable bolster end 306 connects to front bolster 202 when the reduced diameter portion at a second end 403 slides into a bolster aperture 405. Front detachable bolster 306 may be attached to the front bolster via fasteners (not shown) through bolster apertures 406 and bolster end apertures (not shown).

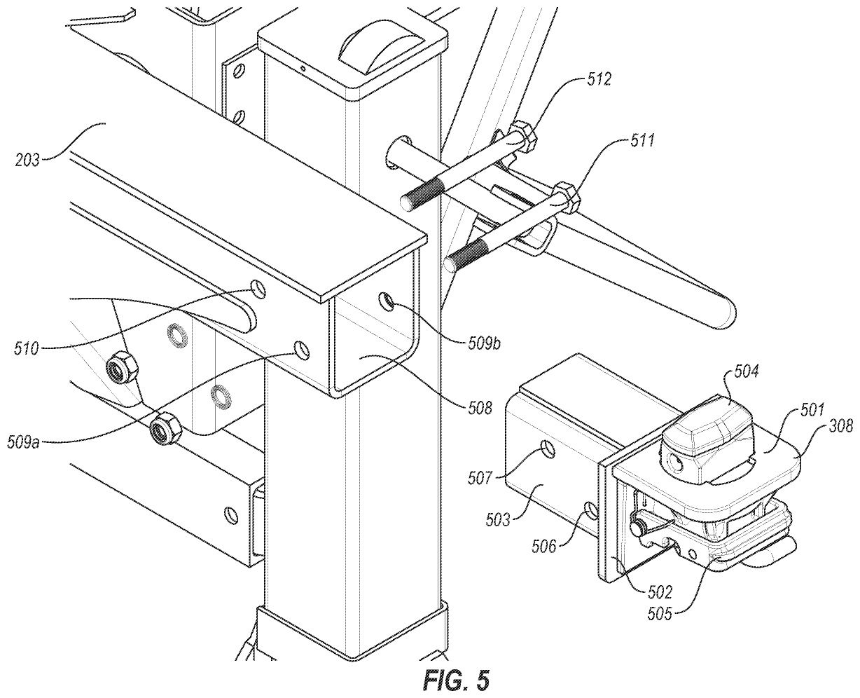

Referring now to FIG. 5, a middle detachable bolster end 308 in one embodiment of a container chassis with detachable bolster ends is shown. Middle detachable bolster end 308 has a top side 501 with a twist lock 504 and twist lock release-engagement mechanism 505, an end plate 502, and a rectangular body portion 503 that is configured to slide inside the mid-bolster 203. In operation, middle detachable bolster end 308 connects to middle bolster 203 when the reduced rectangular body portion 503 slides into a bolster aperture 508. Middle detachable bolster 308 may be attached to the front bolster via fasteners 511, 512 through bolster apertures 509, 510 and bolster end apertures 506, 507.

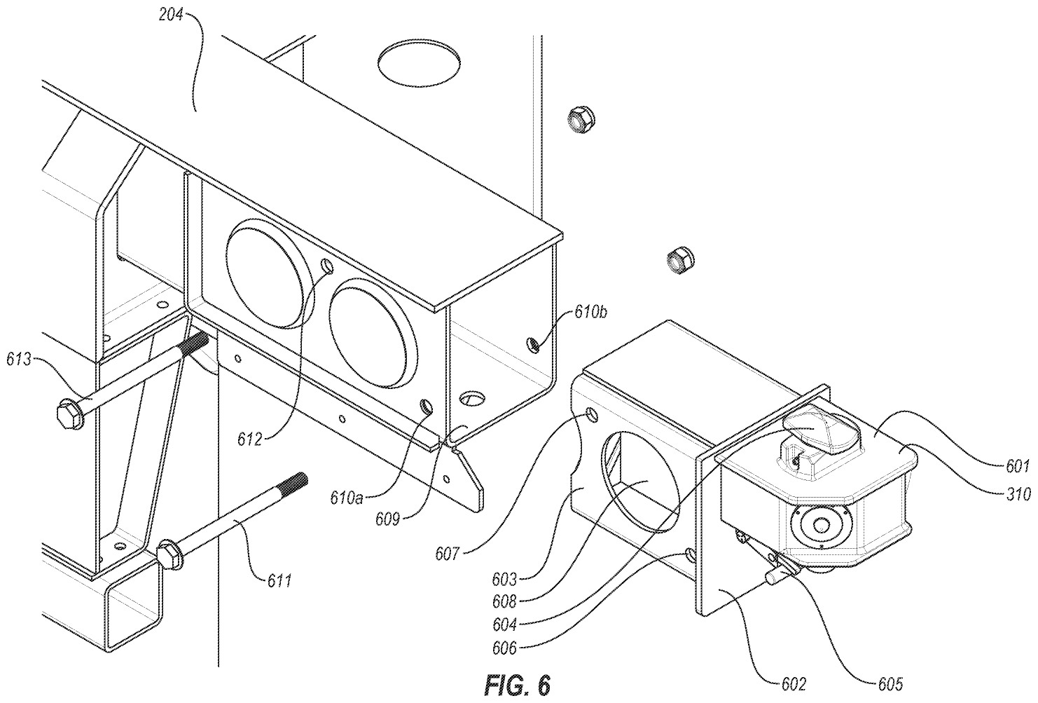

Referring now to FIG. 6, a rear detachable bolster end 310 in one embodiment of a container chassis with detachable bolster ends is shown. Rear detachable bolster end 310 has a top side 601 with a twist lock 604 and twist lock release-engagement mechanism 605, an end plate 602, and a rectangular body portion 603 that is configured to slide inside the rear bolster 204. In operation, rear detachable bolster end 310 connects to rear bolster 204 when the reduced rectangular body portion 603 slides into a bolster aperture 609. Rear detachable bolster 310 may be attached to the rear bolster via fasteners 611, 613 through bolster apertures 610, 612 and bolster end apertures 606, 607.

In operation, when bolster ends are not attached to the chassis, and when outside wheels are removed, the container chassis with detachable bolster ends may easily fit horizontally in an 8 foot-wide shipping container. Because pin and/or twist locks are subject to wear and tear and breakage, the removable bolster ends have the added benefit of additional ease of maintenance (beyond traditional container chassis configurations) by incorporating a modular/interchangeable system wherein a damaged or broken pin and/or twist lock may be individually replaced fairly quickly and easily.

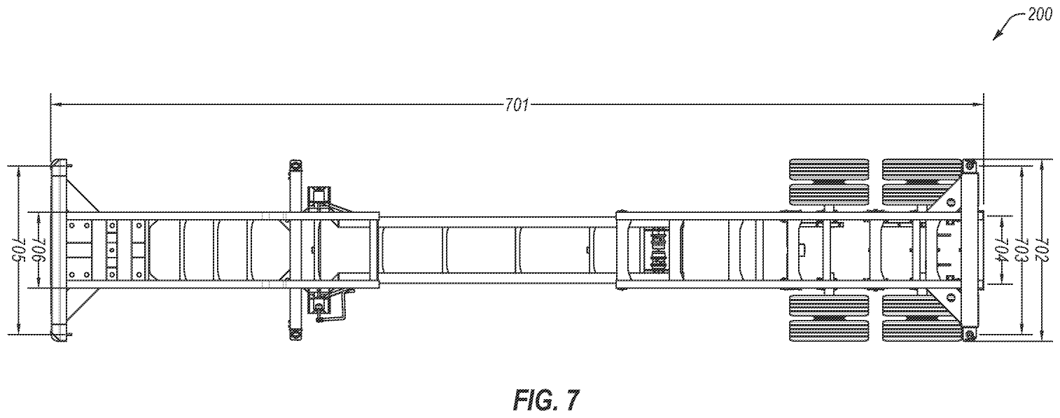

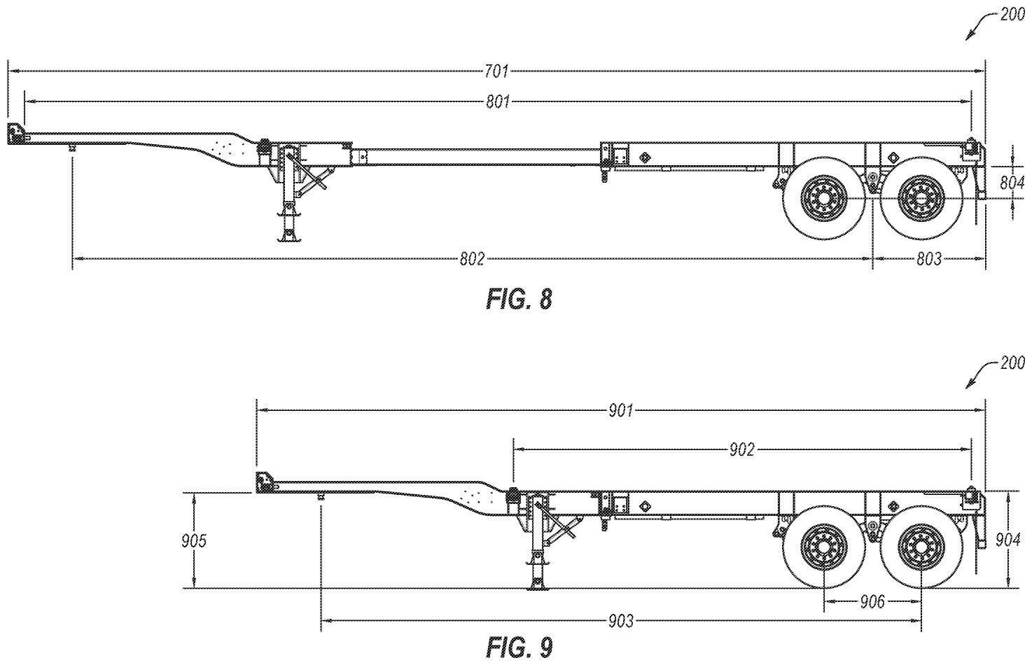

Referring now to FIGS. 7 through 9 various measurements and configurations of preferred embodiments are shown. In some embodiments, the chassis main frame width may be reduced from 8 feet by approximately 12 inches (to around 7 feet) through removal of the detachable bolster ends. The width between chassis tires 702 may be about nine feet six inches. The width between rear and front bolster twist locks 703, 705 may be about seven feet five inches. The width of the chassis frame (less bolsters) 705 may be about three feet four inches. In various embodiments, the container chassis in has a first expanded configuration for transport of forty-foot shipping containers (see, e.g., FIG. 8), and a second contracted configuration for transport of twenty-foot shipping containers (see, e.g., FIG. 9). A forty-foot container shipping configuration of the chassis 701 may be about forty-one feet long; a twenty-foot container shipping configuration of the chassis 901 may be about thirty feet and seven inches long. The tongue height 905 may be about 47 inches.

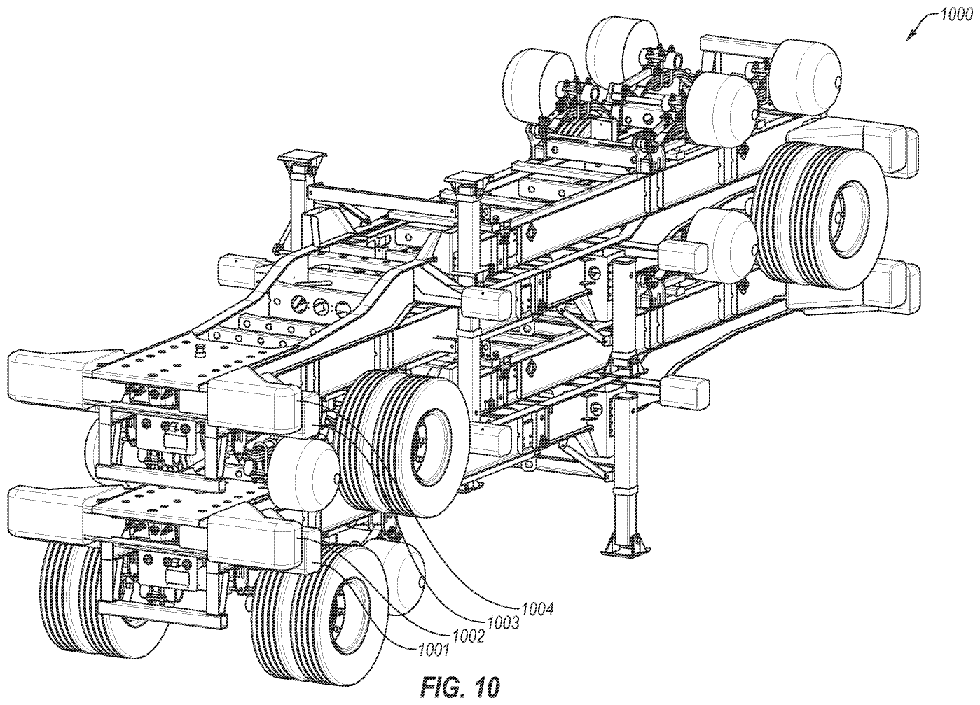

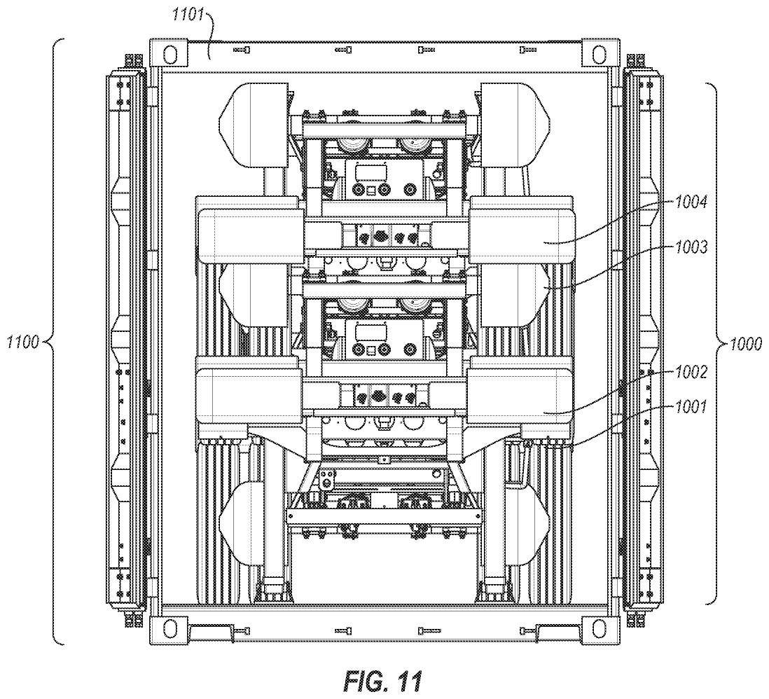

Referring now to FIGS. 10 and 11, container chassis with detachable bolster ends is further configured to be stacked four 1001, 1002, 1003, 1004 or more units high, wherein the resulting stack 1000 is under between 8.5 and 9.5 ft high so as to fit within a standardized cargo container 1100. In order to achieve this stacked configuration, it may be necessary to remove one or more wheels from the chassis and/or to place some chassis on top of each other upside down and/or with alternate-facing ends. So configured, one or more chassis may be easily rolled into a container on its own wheels, without having to be tipped side- or any other ways.

So configured, the container chassis with detachable bolster ends solves the problems of: (1) meeting container chassis demand; (2) unwieldy container chassis configuration; (2) difficulty of loading chassis into containers, and (4) high shipping costs, by providing a container chassis with a design optimized for fitment into a shipping container.

The present invention may be embodied in other specific forms without departing from its spirit or essential characteristics. For example, the illustrated embodiments generally show 20-40 container chassis; however, the detachable bolster ends may be used in many other chassis configurations and/or types, may omit pin locks and/or one or more pairs of twist locks, etc. from the above-described embodiments. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A container chassis with detachable bolster ends comprising:
one or more detachable bolster ends; and
a first configuration with detached bolster ends wherein the container chassis is less than eight feet in width for horizontal fitment into an ISO shipping container.

2. The container chassis with detachable bolster ends of claim 1, further comprising a second configuration with attached bolster ends.

3. The container chassis with detachable bolster ends of claim 1, wherein the container chassis is configured to adjust between a length of between about forty feet to about thirty feet.

4. The container chassis of claim 3, configured for transport of forty-foot and twenty-foot ISO shipping containers.

5. The container chassis with detachable bolster ends of claim 1, further comprising a plurality of bolsters, each bolster with detachable bolster ends.

6. The container chassis with detachable bolster ends of claim 1, further comprising:
a front bolster with detachable bolster ends;
a middle bolster with detachable bolster ends; and
a rear bolster with detachable bolster ends.

7. The container chassis with detachable bolster ends of claim 1, further configured to stack vertically within a plurality of container chassis for fitment into the ISO shipping container.

8. The container chassis with detachable bolster ends of claim 7, the plurality of container chassis configured to be wheeled into the ISO shipping container.

9. The container chassis with detachable bolster ends of claim 1, the first configuration less than seven and a half feet in width.

10. A container chassis with detachable bolster ends comprising:
a plurality of bolsters, each bolster with detachable bolster ends;
a first configuration with detached bolster ends wherein the container chassis is less than eight feet in width for horizontal fitment into an ISO shipping container;
wherein the container chassis is configured to stack vertically within a plurality of container chassis for fitment into the ISO shipping container, the plurality of container chassis further configured to be wheeled into the ISO shipping container.

11. The container chassis with detachable bolster ends of claim 10, further comprising:
a second configuration with attached bolster ends.

12. The container chassis with detachable bolster ends of claim 10, wherein the container chassis is configured to adjust between a length of between about forty feet to about thirty feet.

13. The container chassis with detachable bolster ends of claim 12, further configured for transport of forty-foot and twenty-foot ISO shipping containers.

14. A container chassis with detachable bolster ends comprising:
a front bolster with detachable bolster ends;
a middle bolster with detachable bolster ends; and
a rear bolster with detachable bolster ends;
a first configuration with detached bolster ends wherein the container chassis is less than eight feet in width for horizontal fitment into an ISO shipping container;
a second configuration with attached bolster ends;
wherein the container chassis is configured to adjust between a length of between about forty feet to about thirty feet; and
wherein the container chassis is configured to stack vertically within a plurality of container chassis for fitment into the ISO shipping container, the plurality of container chassis further configured to be wheeled into the ISO shipping container.

15. The container chassis with detachable bolster ends of claim 14, further configured for transport of forty-foot and twenty-foot ISO shipping containers.
